(19) United States
(12) Patent Application Publication
(10) Pub. No.: US 2025/0087719 A1
(43) Pub. Date: Mar. 13, 2025

(54) ENCAPSULATED ELECTRODE AND THE MEANS TO ATTACH IT TO A SOFT GOODS ASSEMB LY (SGA)

(71) Applicant: LOCKHEED MARTIN ENERGY, LLC, Grand Prairie, TX (US)

(72) Inventors: Steven John DASILVA, Somerville, MA (US); Curtis S. WARRINGTON, Acton, MA (US); Louis CASSANO, Belmont, MA (US)

(21) Appl. No.: 18/725,215

(22) PCT Filed: Mar. 16, 2023
(86) PCT No.: PCT/US2023/064502

§ 371 Date: Jun. 28, 2024

Related U.S. Application Data
(60) Provisional application No. 17/703,171, filed on Mar. 24, 2022.

(51) Int. Cl. H01M 8/0297; H01M 4/86; H01M 8/0273; H01M 8/0284; H01M 8/18

(52) U.S. Cl. CPC H01M 8/0297; H01M 4/86; H01M 8/0273; H01M 8/0284; H01M 8/188

(57) ABSTRACT

Provided are electrode assemblies that include framed electrodes comprising a conductive fabric having an edge sealed by an infiltrated sealant, the sealed portion of the fabric being sealed to a frame. Also provided are electrochemical cell stacks that include electrode assemblies according to the present disclosure.

### CROSS-REFERENCE TO RELATED APPLICATIONS

The present application is an international application that claims priority to and the benefit of U.S. patent application Ser. No. 17/703,171, “Encapsulated Electrode And The Means To Attach It To A Soft Goods Assembly (SGA)” (filed Mar. 24, 2022). All foregoing applications are incorporated herein by reference in their entireties for any and all purposes.

### TECHNICAL FIELD

The present disclosure relates to encapsulated electrodes and soft goods assemblies.

### BACKGROUND

Some industrial applications that incorporate stacks of electrochemical cells utilize fabric electrodes, e.g., electrodes fashioned from conductive cloth. Such electrodes, however, can suffer from loose fibers about their perimeters. Further, because conductive cloth is very porous, such electrodes lose their shape easily and can be difficult to attach to other components in a soft goods assembly, particularly in an automated fashion. Accordingly, there is a long-felt need in the art for improved electrode assemblies.

### SUMMARY

In meeting the described needs, the present disclosure provides an encapsulated electrode assembly, comprising: a portion of conductive fabric, the conductive fabric comprising fibers having ends, the portion of conductive fabric defining an edge therearound, a sealed portion of the at least one edge being sealed by a sealant infiltrated into the conductive fabric, the sealant embedding the ends of fibers located along the at least one edge; and a frame, the sealed portion of the at least one edge and the frame being superposed with and attached one another, and the sealed portion of the at least one edge and the frame optionally being sealed directly to one another.

Also provided is an electrode assembly, comprising: (a) a first framed electrode, the first framed electrode comprising a first portion of conductive fabric, the first portion of conductive fabric defining an edge therearound, a sealed portion of the at least one edge being sealed by a sealant infiltrated into the conductive fabric, the sealant embedding the ends of fibers located along the edge, and a first frame, the sealed portion of the at least one edge being sealed to the first frame; (b) a second framed electrode, the second framed electrode comprising a second portion of conductive fabric, the second portion of conductive fabric defining an edge therearound, a sealed portion of the at least one edge being sealed by a sealant infiltrated into the conductive fabric, the sealant embedding the ends of fibers located along the edge, and a second frame, the sealed portion of the at least one edge being sealed to the second frame; and (c) an ion exchange membrane, the first frame and the ion exchange membrane defining a first pocket space between the first portion of conductive fabric and the ion exchange membrane, and the second frame and the ion exchange membrane defining a second pocket space between the second portion of conductive fabric and the ion exchange membrane.

Further disclosed is an electrochemical cell stack, comprising a plurality of electrodes according to the present disclosure.

Also provided is an electrochemical cell stack, comprising a plurality of electrode assemblies according to the present disclosure.

Additionally disclosed is a method of forming an electrode assembly, comprising: sealing an edge of a portion of conductive fabric so as to give rise to an edge-sealed conductor, the conductive fabric comprising fibers having ends, the sealing comprising effecting infiltration of a sealant into the conductive fabric so as to give rise to a sealed edge extending around the portion of conductive fabric, the sealant embedding the ends of fibers located along the at least one edge, and the sealant optionally effecting a tension across the conductive fabric.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. Unless otherwise stated, the drawings are not to scale. In the drawings:

FIG. 1A provides a view of a conductive fabric with sealant applied about the edge of the fabric;

FIG. 1B provides a view of the conductive fabric of FIG. 1A after sealant infiltration and sealant curing;

FIG. 2A provides a cross-sectional view of an exemplary electrode assembly according to the present disclosure; and

FIG. 2B provides an exploded view of the exemplary electrode shown in FIG. 2A.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints, 2 grams and 10 grams, and all the intermediate values. The endpoints of the ranges and any values disclosed herein are not limited to the precise range or value; they are sufficiently imprecise to include values approximating these ranges and/or values.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4.

Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

### FIGURES

The attached figures (and their related descriptions) are illustrative only and do not serve to limit the scope of the present disclosure or the appended claims.

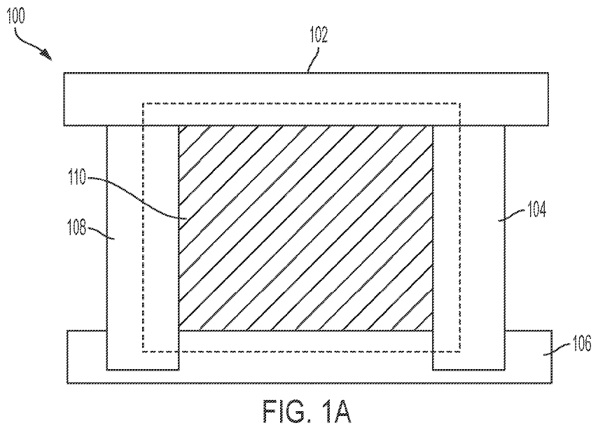

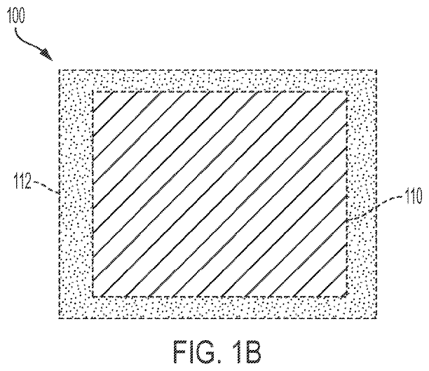

As shown in FIG. 1A, a portion 110 of a conductive fabric (which conductive fabric can be fibrous) can have sealant applied about or on the edge(s) of the fabric. For example, polymer portions 102, 104, 106, and 108 can be applied over the edges of the fabric such that polymer is superposed over each edge (and the ends of any fiber located at each edge). The polymer can be present in wet, green, or otherwise uncured form, e.g., in the case of a thermoset. Alternatively, the polymer can be present as a ribbon, e.g., a polypropylene ribbon. The polymer need not, however, be present in ribbon or strip form, as polymer can also be sprayed, dripped, rollered, or otherwise applied to the fabric, e.g., via dipping the fabric into the polymer.

The polymer can be (e.g., in the case of a thermoplastic) heated or otherwise processed (e.g., via ultrasound) so that the polymer infiltrates into the fabric so as to seal the edge(s) of the fabric. The polymer can, e.g., embed the ends of fibers located along the edge(s) such that that the ends are not “free” and do not protrude from the polymer. This is not a requirement, however, as the polymer can also simply act to secure the ends of the fibers such that the ends do not detach from the fabric.

FIG. 1B shows an electrode 100 following sealant (e.g., polymer) infiltration and curing, and also after the edge of electrode 100 has been processed (e.g., via cutting) to the desired dimensions. The sealed portion 112 of electrode 110 can be of uniform width around the edge of the electrode 100, but this is not a requirement, as the sealed portion 112 can have a variable width around the perimeter of electrode 100.

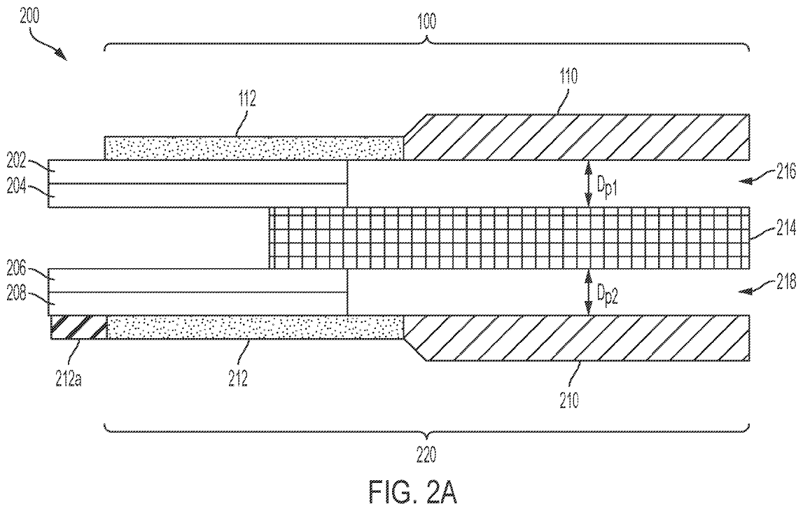

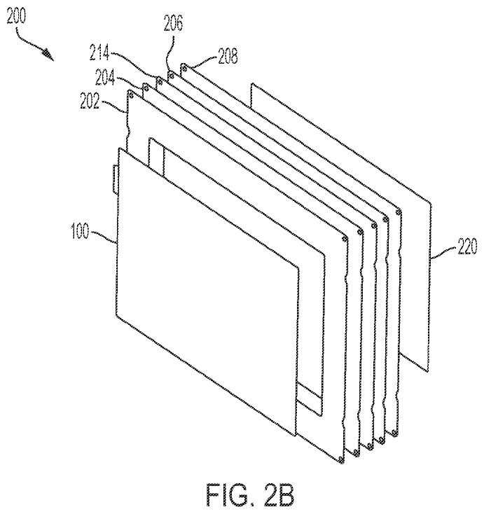

FIG. 2A provides a cross-sectional view of an electrode assembly 200 according to the present disclosure. As shown, an ion exchange membrane 214 can be secured to frame 202 via adhesive 204 and to frame 208 via adhesive 206. Electrode 100 (comprising conductive fabric 110 and sealed portion 112) can be attached to frame 202, e.g., via ultrasonic welding that joins sealed portion 112 to frame 202.

As described elsewhere herein, the sealant in the sealed portion 112 can be the same material (e.g., a polypropylene) as the material of frame 202; without being bound to any particular theory or embodiment, such material matching can facilitate the use of ultrasonic welding to join sealed portion 112 and frame 202.

Although not shown, an adhesive can also be used to join sealed portion 112 to frame 202. Similarly, a second electrode 220 (comprising conductive fabric 210 and sealed portion 212, which can be similar or even identical to the conductive fabric 110 and sealed portion 112 of electrode 100) can be included, e.g., via bonding between sealed portion 212 and frame 208. Such bonding can be effected by ultrasonic welding. An adhesive can also be used to bond sealed portion 212 to frame 208. The second electrode can be formed by, e.g., infiltration of polymer into a conductive fabric, as explained elsewhere herein in connection with first electrode 110.

As shown in FIG. 2A, conductive fabric 110 and ion exchange membrane 214 can define a pocket 216 therebetween. Such a pocket (having a depth Dₚ₁) can receive an active material, such as an electrolyte) that exchanges ions across ion exchange membrane 214 with another active material on the other side of ion exchange membrane 214. Such pocket 216 can be configured such that conductive material 110 is wetted by active material and is then exerted into pocket 216.

A second pocket 218 (having depth Dₚ₂) can also be formed between ion exchange membrane 214 and conductive material 210. Second pocket 218 can be configured such that conductive material 210 is wetted by active material and is then exerted into pocket 218. In this way, active material entrained or flowing within conductive fabric 110 can exchange ions (across ion exchange membrane 214) with active material entrained or flowing within conductive fabric 210.

Without being bound to any particular theory or approach, during operation the conductive fabric 110 can be pressed (e.g., by a bipolar plate or a monopolar plate) through the pocket (i.e., 216 or 218) in the direction of the ion exchange membrane 214. The conductive fabric can be pressed such that it contacts the ion exchange membrane, although this is not a requirement. Direct physical contact between the fabric and the ion exchange membrane can facilitate contact between an active material (e.g., an electrolyte) that has wetted the fabric and the ion exchange membrane. An assembly can be configured such that an ion exchange membrane experiences an approximately equal pressure from both sides during operation, though this is not a requirement. By reference to FIG. 2A, this can be accomplished when ion exchange membrane 214 experiences equal pressures from conductive fabric portions 110 and 210 during operation.

The thickness of the conductive fabric, the basis weight of the conductive fabric, the depth of the pocket between the conductive fabric and the ion exchange membrane, and the amount of pressure exerted against the conductive fabric during operation can all be selected to as to allow for a desired level of fluid flow (e.g., wetting) within the conductive fabric. For example, the basis weight can be from about 100 to about 600 g/m. The depth of the pocket can be, e.g., from about 10% to about 50% of the electrode thickness. The thickness of the conductive fabric can be, e.g., from about 100 to about 1500 μm.

It should be understood that although conductive fabric 110 is shown as tapering and reducing in thickness in the direction of the sealed portion 112, this is not a requirement, as the thickness of sealed region 112 can also be greater or equal to the thickness of the unsealed portion of conductive fabric 110.

FIG. 2B provides an exploded view of electrode assembly 200. As shown, electrode 110 can be assembled to frame 202 (e.g., ultrasonic welding), with adhesive 204 used to secure frame 202 to ion exchange membrane 214. Ion exchange membrane can in turn be secured via adhesive 206 to frame 208. Frame 208 can in turn be secured, e.g., via ultrasonic welding) to second electrode 220.

### EMBODIMENTS

The following Embodiments are illustrative only and do not limit the scope of the present disclosure or the appended claims. Any part or parts of any one or more Embodiments can be combined with any part or parts of any one or more other Embodiments.

Embodiment 1. An encapsulated electrode assembly, comprising: a portion of conductive fabric, the conductive fabric comprising fibers having ends, the portion of fibrous fabric defining an edge therearound, a sealed portion of the at least one edge being sealed by a sealant infiltrated into the conductive fabric, the sealant embedding the ends of fibers located along the at least one edge; and a frame, the sealed portion of the at least one edge and the frame being superposed with and attached one another, and the sealed portion of the at least one edge and the frame optionally being sealed directly to one another.

Embodiment 2. The encapsulated electrode of embodiment 1, wherein the sealant and the frame comprise the same material. As an example, both the sealant and the frame can be polypropylene.

Embodiment 3. The encapsulated electrode of embodiment 1, wherein at least one of the sealant and the frame comprises one or more of polyethylene, polypropylene, polyvinyl chloride, or any combination thereof. The sealant and the frame can comprise materials that have the same melting temperature. The sealant and the frame can comprise materials that have melting temperatures that differ from one another by less than 30° C., less than 25° C., less than 20° C., less than 15° C., less than 10° C., or even less than 5° C.

Embodiment 4. The encapsulated electrode of embodiment 1, wherein the sealed portion and the frame are integral with one another. The sealed portion of the at least one edge and the frame are optionally ultrasonically welded to one another.

It should be understood that ultrasonic welding is not the exclusive or only approach to joining the sealed potion and the frame. The sealed portion and the frame can also be joined via adhesive or other joining material. For example, the sealed portion and the frame can both be joined to a strip of polymer (e.g., polypropylene) disposed between the sealed portion and the frame. The joining material can be the same material as the frame and/or the sealed portion, but this is not a requirement.

Embodiment 5. The encapsulated electrode of embodiment 1, wherein the conductive fabric is woven.

Embodiment 6. The encapsulated electrode of embodiment 1, wherein the conductive fabric is nonwoven. The fabric can be knitted, but this is not a requirement.

Embodiment 7. The encapsulated electrode of embodiment 1, wherein the sealed portion extends around essentially the entire perimeter of the portion of conductive fabric.

Embodiment 8. The encapsulated electrode of embodiment 7, wherein the sealed portion effects (i.e., gives rise to) a tension across the conductive fabric.

Embodiment 9. The encapsulated electrode of embodiment 1, wherein the sealed portion defines a width of from about 2 mm to about 10 mm.

Embodiment 10. The encapsulated electrode of embodiment 1, wherein the sealant extends beyond the edge of the portion of fibrous fabric. This is shown by element 212a in non-limiting FIG. 2A, which element (212a) illustrates an amount of sealant that extends beyond the edge of sealed portion 212 of the conductive fabric.

Embodiment 11. An electrode assembly, comprising: (a) a first framed electrode, the first framed electrode comprising a first portion of conductive fabric, the first portion of conductive fabric defining an edge therearound, a sealed portion of the at least one edge being sealed by a sealant infiltrated into the conductive fabric, the sealant embedding the ends of fibers located along the edge, and a first frame, the sealed portion of the at least one edge being sealed to the first frame; (b) a second framed electrode, the second framed electrode comprising a second portion of conductive fabric, the second portion of conductive fabric defining an edge therearound, a sealed portion of the at least one edge being sealed by a sealant infiltrated into the conductive fabric, the sealant embedding the ends of fibers located along the edge, and a second frame, the sealed portion of the at least one edge being sealed to the second frame; and (c) an ion exchange membrane, the first frame and the ion exchange membrane defining a first pocket space between the first portion of conductive fabric and the ion exchange membrane, and the second frame and the ion exchange membrane defining a second pocket space between the second portion of conductive fabric and the ion exchange membrane.

Embodiment 12. The electrode assembly of embodiment 11, wherein at least one of the first pocket space and the second pocket space defines a depth of from about 0 mm to about 1 mm, including 0 mm.

Embodiment 13. The electrode assembly of embodiment 11, wherein (a) the first frame is sealed to the ion exchange membrane using a sealant so as to form the first pocket space, (b) the second frame is sealed to the ion exchange membrane using a sealant so as to form the second pocket space, or both (a) and (b).

Embodiment 14. The electrode assembly of embodiment 11, wherein (a) the first frame is sealed to the ion exchange membrane by applied pressure and/or an adhesive so as to form the first pocket space, (b) the second frame is sealed to the ion exchange membrane by applied pressure and/or an adhesive so as to form the second pocket space, or both (a) and (b). An adhesive used to seal a frame to an ion exchange membrane can comprise the same material (e.g., polypropylene) as the frame, though this is not a requirement.

In some embodiments, the frame is sealed to the ion exchange membrane by sealing the frame directly to the membrane, e.g., via heating the frame so as to melt a portion of the frame to seal to the membrane. This is not a requirement, and the frame can be sealed to the membrane in a variety of ways.

Embodiment 15. The electrode assembly of embodiment 11, wherein the first frame defines a thickness in the range of from about 80 micrometers to about 1000 micrometers.

Embodiment 16. The electrode assembly of embodiment 11, wherein the sealant extends beyond the edge of the first portion of conductive fabric; a conductive fabric can be, e.g., a fibrous fabric.

Embodiment 17. An electrochemical cell stack, comprising one or more electrodes according to any one of embodiments 1-10, one or more electrode assemblies according to any one of embodiments 11-16, or any combination thereof.

Embodiment 18. The electrochemical cell stack of embodiment 17, wherein the plurality of electrodes are maintained in position by application of a pressure exerted between end plates flanking the plurality of electrodes. Without being bound to any particular theory or embodiment, the electrodes can be sandwiched between flow plates (e.g., bipolar plates, monopolar plates, and the like).

Embodiment 19. The electrochemical cell stack of embodiment 17, wherein the conductive fabric of the electrodes is wetted by an active material. Such an active material can be, e.g., a negolyte, or a posolyte. The active material can be communicated to the conductive fabric via, e.g., a flow plate.

Embodiment 20. An electrochemical cell stack, comprising a plurality of electrode assemblies according to embodiment 11.

Embodiment 21. The electrochemical cell stack of embodiment 20, wherein the conductive fabric (which can be, e.g., a fibrous fabric) of the electrodes is wetted by an active material.

Embodiment 22. The electrochemical stack of any one of embodiments 17 to 21, the electrochemical stack being in electrical communication with an electrical load.

Embodiment 23. A method of forming an electrode assembly, comprising: sealing an edge of a portion of conductive fabric so as to give rise to an edge-sealed conductor, the conductive fabric comprising fibers having ends, the sealing comprising effecting infiltration of a sealant into the conductive fabric so as to give rise to a sealed edge extending around the portion of conductive fabric, the sealant embedding the ends of fibers located along the at least one edge, and the sealant optionally effecting a tension across the conductive fabric.

Embodiment 24. The method of embodiment 23, further comprising affixing the edge-sealed conductor to a framed ion exchange membrane, the affixing defining a pocket space between the portion of conductive fabric and the ion exchange membrane.

Embodiment 25. The method of embodiment 24, wherein the affixing comprises ultrasonic welding.

Any aspect of the foregoing can be performed manually, but can also be performed in an automated fashion. Any aspect of the foregoing can be performed in a batch manner, a semi-batch manner, a continuous manner, e.g., in a roll-to-roll fashion, and the like.

For example, frames can be sealed to portions (e.g., squares, rectangles) of conductive fabric in a continuous manner. This can be accomplished by, e.g., applying sealant to the portions of conductive fabric in a batch-type manner and then—also in a batch-type manner-sealing frames to the sealed regions of the conductive fabric.

Attaching the frames to the ion exchange membranes can also be performed manually or in an automated fashion. Attaching the frames to the ion exchange membranes can also be performed in a batch manner, a semi-batch manner, or in a continuous manner.

1. An encapsulated electrode assembly, comprising:
a portion of conductive fabric, the conductive fabric comprising fibers having ends,
the portion of fibrous fabric defining an edge therearound,
a sealed portion of the at least one edge being sealed by a sealant infiltrated into the conductive fabric,
the sealant embedding the ends of fibers located along the at least one edge; and a frame,
the sealed portion of the at least one edge and the frame being superposed with and attached one another, and
the sealed portion of the at least one edge and the frame optionally being sealed directly to one another.

2. The encapsulated electrode of claim 1, wherein the sealant and the frame comprise the same material.

3. The encapsulated electrode of claim 1, wherein at least one of the sealant and the frame comprises one or more of polyethylene, polypropylene, polyvinyl chloride, or any combination thereof.

4. The encapsulated electrode of claim 1, wherein the sealed portion and the frame are integral with one another, and the sealed portion of the at least one edge and the frame are optionally ultrasonically welded to one another.

5. The encapsulated electrode of claim 1, wherein the conductive fabric is woven.

6. The encapsulated electrode of claim 1, wherein the conductive fabric is nonwoven.

7. The encapsulated electrode of claim 1, wherein the sealed portion extends around essentially the entire perimeter of the portion of conductive fabric.

8. The encapsulated electrode of claim 7, wherein the sealed portion effects a tension across the conductive fabric.

9. The encapsulated electrode of claim 1, wherein the sealed portion defines a width of from about 2 mm to about 10 mm.

10. The encapsulated electrode of claim 1, wherein the sealant extends beyond the edge of the portion of fibrous fabric.

11. An electrode assembly, comprising:
(a) a first framed electrode, the first framed electrode comprising
(1) a first portion of conductive fabric,
the first portion of conductive fabric defining an edge therearound,
a sealed portion of the at least one edge being sealed by a sealant infiltrated into the conductive fabric, the sealant embedding the ends of fibers located along the edge, and
(2) a first frame,
the sealed portion of the at least one edge being sealed to the first frame;
(b) a second framed electrode, the second framed electrode comprising
(1) a second portion of conductive fabric,
the second portion of conductive fabric defining an edge therearound,
a sealed portion of the at least one edge being sealed by a sealant infiltrated into the conductive fabric, the sealant embedding the ends of fibers located along the edge, and
(2) a second frame,
the sealed portion of the at least one edge being sealed to the second frame; and
(c) an ion exchange membrane,
the first frame and the ion exchange membrane defining a first pocket space between the first portion of conductive fabric and the ion exchange membrane, and
the second frame and the ion exchange membrane defining a second pocket space between the second portion of conductive fabric and the ion exchange membrane.

12. The electrode assembly of claim 11, wherein at least one of the first pocket space and the second pocket space defines a depth of from about 0 mm to about 1 mm.

13. The electrode assembly of claim 11, wherein (a) the first frame is sealed to the ion exchange membrane using a sealant so as to form the first pocket space, (b) the second frame is sealed to the ion exchange membrane using a sealant so as to form the second pocket space, or both (a) and (b).

14. The electrode assembly of claim 11, wherein (a) the first frame is sealed to the ion exchange membrane by applied pressure so as to form the first pocket space, (b) the second frame is sealed to the ion exchange membrane by applied pressure so as to form the second pocket space, or both (a) and (b).

15. The electrode assembly of claim 11, wherein the first frame defines a thickness in the range of from about 80 micrometers to about 1000 micrometers.

16. The electrode assembly of claim 11, wherein the sealant extends beyond the edge of the first portion of conductive fabric.

17. An electrochemical cell stack, comprising one or more electrodes according to claim 1.

18. An electrochemical cell stack, comprising one or more electrode assemblies according to claim 11.

19. The electrochemical cell stack of claim 17, wherein the plurality of electrodes are maintained in position by application of a pressure exerted between end plates flanking the plurality of electrodes.

20. The electrochemical cell stack of claim 17, wherein the fibrous fabric of the electrodes is wetted by an active material.

21. An electrochemical cell stack, comprising a plurality of electrode assemblies according to claim 11.

22. The electrochemical cell stack of claim 21, wherein the conductive fabric of the electrodes is wetted by an active material.

23. The electrochemical stack of claim 17, the electrochemical stack being in electrical communication with an electrical load.

24. A method of forming an electrode assembly, comprising:
sealing an edge of a portion of conductive fabric so as to give rise to an edge-sealed conductor, the conductive fabric comprising fibers having ends,
the sealing comprising effecting infiltration of a sealant into the conductive fabric so as to give rise to a sealed edge extending around the portion of conductive fabric,
the sealant embedding the ends of fibers located along the at least one edge, and
the sealant optionally effecting a tension across the conductive fabric.

25. The method of claim 24, further comprising affixing the edge-sealed conductor to a framed ion exchange membrane, the affixing defining a pocket space between the portion of conductive fabric and the ion exchange membrane.

26. The method of claim 25, wherein the affixing comprises ultrasonic welding.

27. The encapsulated electrode of claim 1, wherein the sealed portion and the frame are sealed to one another with an adhesive.

28. The encapsulated electrode of claim 1, wherein the sealed portion of the at least one edge and the frame are sealed directly to one another.
